(19) United States
(12) Patent Application Publication
(10) Pub. No.: US 2007/0048496 A1
(43) Pub. Date: Mar. 1, 2007

(54) Laminating film

(76) Inventor: Toshikatsu Nishitani, Obama-shi (JP)

Correspondence Address: MILDE & HOFFBERG, LLP, 10 BANK STREET, SUITE 460, WHITE PLAINS, NY, 10606, US

(21) Appl. No.: 11/215,425

(22) Filed: Aug. 30, 2005

(51) Int. Cl. B32B 3/10

(52) U.S. Cl. 428/136

(57) ABSTRACT

There is provided a sheet of laminating films which comprises an upper film and a lower film overlapping each other for laminating pictures and drawings or the like by sandwiching them between the upper and lower films, wherein the upper film and the lower film are welded to provide a binding margin at a side edge of the sheet of laminating films, wherein the upper film and the lower film are welded to provide a welding part at an end part extending from one end of the binding margin, and wherein the upper film is removed in the form of a slit along the binding margin.

### BACKGROUND OF THE INVENTION

1. Field of the Invention

The present invention relates to a sheet of laminating films that may be bound as a book or a file while sandwiching pictures or the like between the films.

2. Description of Related Art

Conventionally, laminating films are used for the purpose of preserving pictures, documents, drawings or the like for a long period of time. As shown in FIGS. 5(a) and 5(b), a conventional sheet 20 of laminating films is formed so that two films 21 and 22 overlap each other while welding an upper part 23 thereof. That is, it is formed so that the two films 21 and 22 overlap each other in a pair.

FIGS. 6(a) and 6(b) respectively show a case when pictures 24 are sandwiched and laminated between the two films 21 and 22. That is, when the films 21 and 22 sandwiching the pictures 24 are heated and pressed, the films 21 and 22 are stiffened by being welded and become one hard sheet 25.

By the way, the plurality of sheets 25 may be bound as a file by punching holes 26 on the left side thereof and tying by a string. However, even if they may be bound together by the string, its binding force is weak and the plurality of sheets 25 are merely kept so as not to come apart. Moreover, it is hard to turn over the respective sheets 25 in the state when they are bound by the string.

The hard and stiff sheets 25 become loosen even if they are bound by the string and it is actually impossible to bind as a file. Although the sheets 25 will not become loose by binding the side part thereof by fittings such as a stapler, it becomes unable to turn over such hard sheets 25 one by one.

### SUMMARY OF THE INVENTION

A sheet of laminating films according to the present invention comprises an upper film and a lower film overlapping each other for laminating pictures and drawings or the like by sandwiching them between those films, wherein the upper and lower films are welded to provide a binding margin at a side edge of the sheet of laminating films, wherein the upper and lower films are welded to provide a welding part at an end part extending from one end of the binding margin, and wherein the upper film is removed in the form of a slit along the binding margin.

Further, the sheet of laminating films according to the present invention comprises an upper film and a lower film overlapping each other for laminating pictures and drawings or the like by sandwiching them between those films, wherein the upper and lower films are welded to provide a welding part at the side edge of the sheet of laminating films, and wherein the upper film is removed in the form of a slit along an end part extending from one end of the welding part.

The sheet of laminating films according to the present invention is capable of sandwiching and preserving pictures, drawings, and documents or the like as usual. In the present invention, the side end of the sheet that is connected by one film is formed as an easily bendable thin folding line by removing the upper film in the form of a slit along the binding margin. As a result, a file of the sheets may be made by stacking the plurality of sheets and by fixing their binding margin by a metal fitting or the like and in addition to that, the filed plurality of sheets may be turned over one by one. Accordingly, it is convenient in filing and preserving the plurality of sheets in which pictures and drawings or the like are sandwiched and it allows them to be readily observable.

### BRIEF DESCRIPTION OF THE DRAWING

FIG. 1(a) is a plain view showing an embodiment of a sheet of laminating film of the present invention.

FIG. 1(b) is a cross sectional view taken on line A-A of the sheet of laminating films shown in FIG. 1(a).

FIG. 2(a) is a plain view of a sheet obtained by laminating pictures with the laminating films shown in FIG. 1(a).

FIG. 2(b) is a cross sectional view taken on line B-B of the sheet shown in FIG. 2(a).

FIG. 3(a) is a plain view showing another embodiment of a sheet of laminating films of the present invention.

FIG. 3(b) is a cross sectional view taken on line C-C of the sheet of laminating films of the present invention shown in FIG. 3(a).

FIG. 4 is a plain view showing still further embodiment of a sheet of laminating films of the present invention.

FIG. 5(a) is a plain view showing a conventional sheet of laminating films.

FIG. 5(b) is a cross sectional view taken on line D-D of the sheet of the laminating films shown in FIG. 5(a).

FIG. 6(a) is a plain view of a sheet obtained by laminating pictures with the laminating films shown in FIG. 5(a).

FIG. 6(b) is a cross sectional view taken on line E-E of the sheet of the laminating films shown in FIG. 6(a).

### DESCRIPTION OF THE PREFERRED EMBODIMENTS

Now, specific embodiments of the present invention will be described in detail with reference to the accompanying drawings. The present invention is not limited to these embodiments shown below.

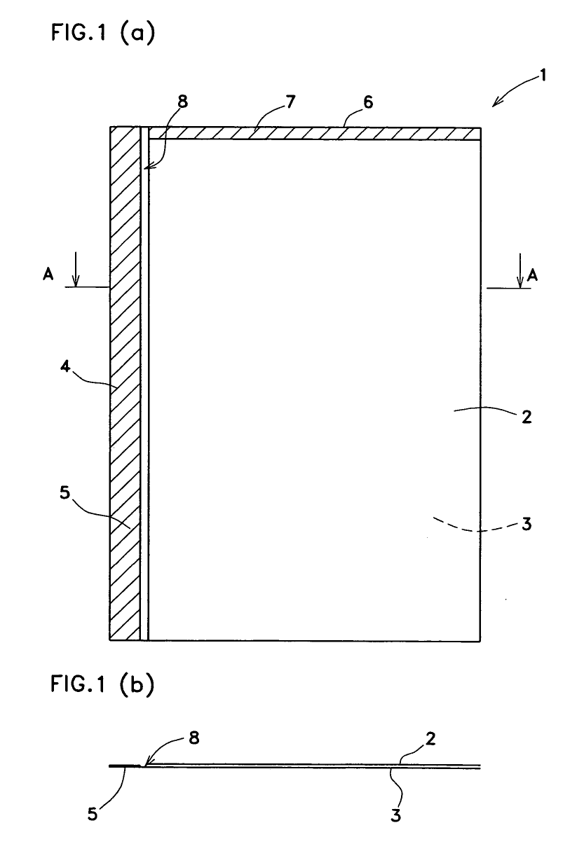

FIGS. 1(a) and 1(b) respectively show an embodiment of a sheet of laminating films of the present invention. A sheet 1 of laminating films comprises an upper film 2 and a lower film 3 overlapping each other. And the overlapped upper film 2 and lower film 3 are welded by heating to provide a binding margin 5 at a side edge 4 of the sheet 1 of laminating films. Further, the upper film 2 and lower film 3 are welded by heating to provide a welding part 7 at an end part 6 of the sheet 1 of laminating films extending from one end of the binding margin 5.

In the upper film 2 according to the sheet 1 of laminating films, a portion of the upper film 2 is removed in the form of a slit along the binding margin 5. A portion where only the lower film 3 is left by removing a portion of the upper film 2 in the form of a slit is referred to as a removed part 8.

More specifically, the upper film 2 may be separated from the binding margin 5 by removing a portion of the upper film 2 in the form of a slit along the binding margin 5. Accordingly, when sandwiching pictures and drawings or the like between the upper film 2 and lower film 3, the upper film 2 may be turned up, allowing the pictures and the drawings or the like easily sandwiched as well as a sheet 20 of laminating films.

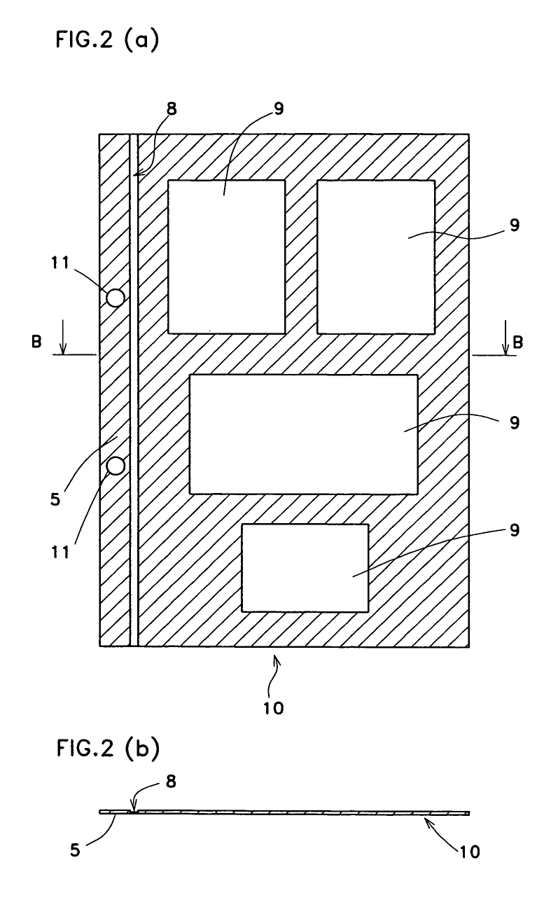

When the sheet 1 of laminating films sandwiching pictures 9 is heated and pressed, it turns out to be one stiff sheet 10 as shown in FIGS. 2(a) and 2(b). However, when compared to other parts in the sheet 10, the removed part 8 has low stiffness because only the lower film 3 is left there. Accordingly, the sheet 10 is capable of easily bending the removed part 8 as a folding line.

As mentioned above, in the sheet 1 of laminating films according to the present invention, one stiff sheet 10 having the bending margin 5 is obtained by heating and pressing while sandwiching the pictures 9 or the like between the upper film 2 and lower film 3 because the bending margin 5 is previously formed in the sheet 1. The sheet 10 is capable of preventing the pictures 9 or the like sandwiched between the upper film 2 and the lower film 3 according to the sheet 1 of laminating films for a long period of time without being damaged by stain, bend or discoloration.

Further, the plurality of sheets 10, 10, . . . may be bound as a book or a file by fixing the binding margins 5, 5, . . . by metal fittings or by perforating holes 11 and binding by a string as shown in FIG. 2(a). Moreover, the plurality of sheets 10 may easily bend the removed part 8 as a folding line, so that the sheets 10 may be turned over one by one while being bound by respective binding margins 5, 5, . . . . Accordingly, the contents of the arbitrary sheet 10 can be easily seen.

Embodiments of the sheet 1 of laminating films according to the present invention have been described so far, but the present invention is not limited to these embodiments.

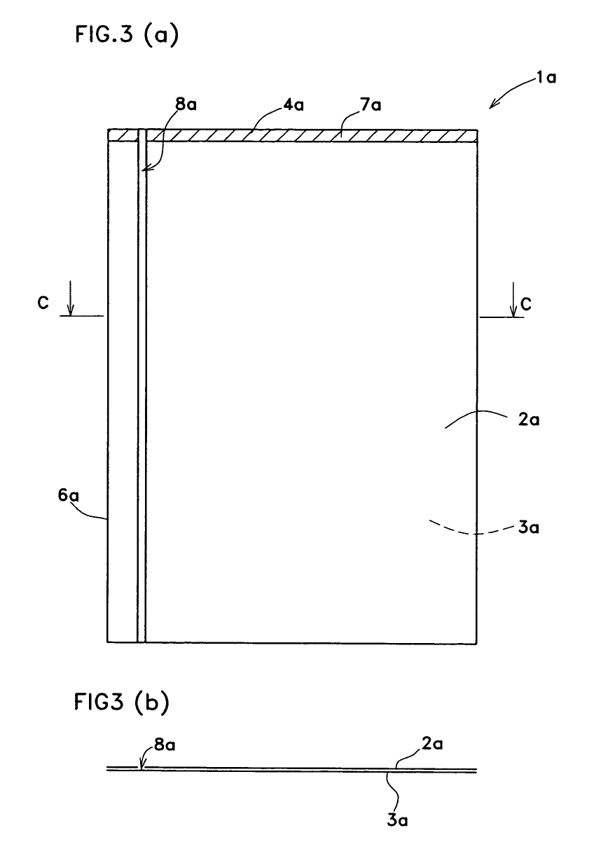

For example, a sheet la of laminating films shown in FIGS. 3(a) and 3(b) comprises an upper film 2a and a lower film 3a overlapping each other as well as the sheet 1 of laminating films. The overlapped upper film 2a and lower film 3a are welded by heating to provide a welding part 7a at a side edge 4a in the sheet 1a of laminating films.

In addition, a portion of the upper film 2a in the sheet 1a of laminating films close to an end part 6a is removed in the form of a slit along the end part 6a extending from one end of the welding part 7a. The place where only the lower film 3a is left after removing a portion of the upper film 2a close to the end part 6a is referred to as a removed part 8a.

More specifically, the upper film 2a may be divided into two by removing a portion of the upper film 2a in the form of a slit along the proximity of the end part 6a. When pictures and drawings or the like are sandwiched between the upper film 2a and the lower film 3a, the pictures and drawings or the like may be easily sandwiched while one end of the divided upper film 2a is turned up. In addition, a stiff sheet like the sheet 10 shown in FIGS. 2(a) and 2(b) may be obtained by pressing the sheet 1a of laminating films sandwiching pictures and drawings or the like while it is heated. That is, when compared to other portions in the obtained sheet, the removed part 8a has low stiffness and may easily bend the removed part 8a as a folding line because only the lower film 3a is left.

In the sheet 1a of laminating films according to the embodiments in the present invention, when the sheet 1a is pressed and heated while sandwiching pictures and drawings or the like, a sheet of laminating films where a binding margin is provided and which is capable of easily bending the removed part 8a as a folding line may be obtained by removing a portion of the upper film 2a and dividing the upper film 2a into two along the proximity of the end part 6a. The above-mentioned similar effects are obtained because this is similar to the sheet 10 obtained from the sheet 1 of laminating films.

The embodiments of the sheet of laminating films according to the present invention have thus been described. However, the size of the sheet of laminating films according to the present invention is not limited. That is, the sheet may be formed as a vertical and horizontal type sheet in which the binding margin is provided within the regular sheet of sizes L, 2L, B5, B4, A4, and A3 and the like or a vertical and horizontal type sheet in which the binding margin is provided without the regular sheet of sizes. More specifically, the aspects in which the binding margin according to the present invention provided are not limited to those shown in the figures, but the binding margin may be provided at the side of the end part 6 in the sheet 1 of laminating films shown in FIG. 1(a).

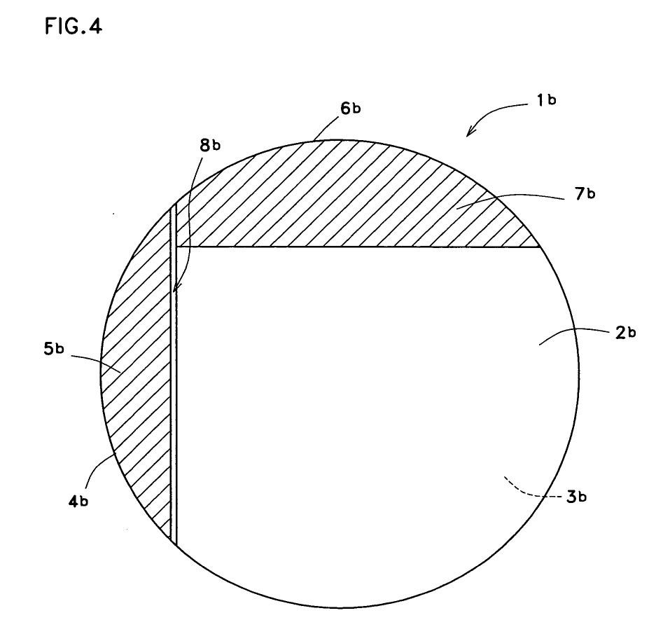

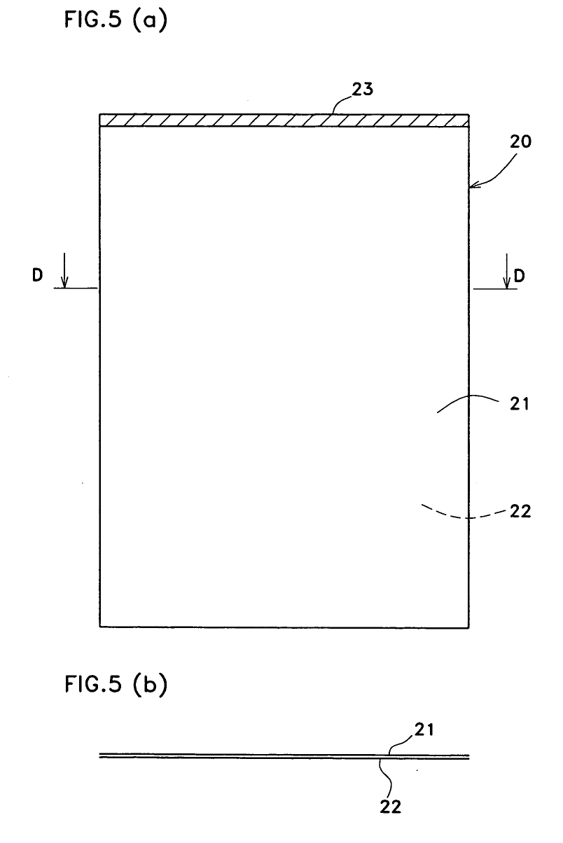

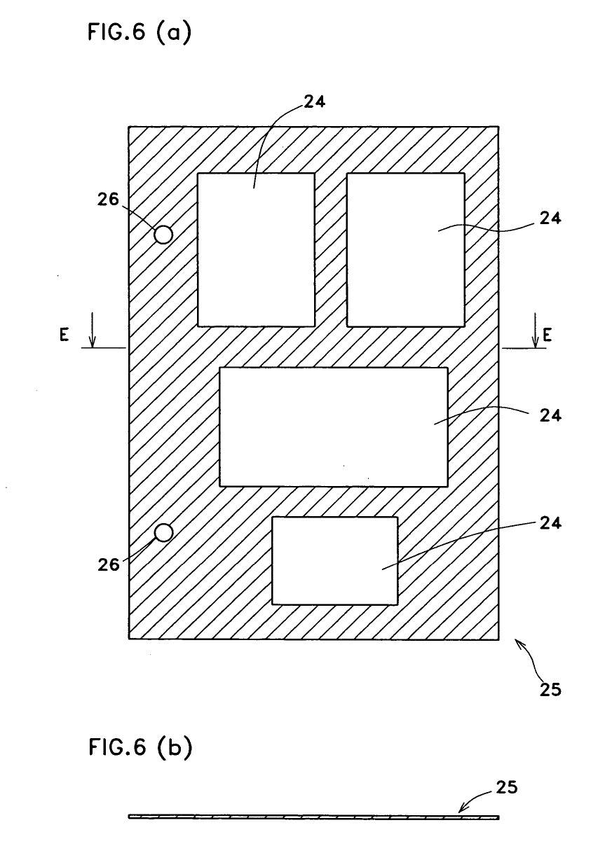

Furthermore, the shape of the sheet of laminating films of the present invention is not limited to a rectangle shown in each figure and may be any one of a square, a triangle, a polygon, such as a pentagon or more, a circle or an oval or the like. For example, the sheet 1b of laminating films shown in FIG. 4 comprises an upper film 2b and a lower film 3b in the shape of a circle overlapping each other and the overlapped upper film 2b and lower film 3b are welded by heating to provide a binding margin 5b at a side edge 4b of the sheet 1b of laminating films. Further, the upper film 2b and lower film 3b are welded by heating to provide a welding part 7b at an end part 6b of the sheet 1b extending from one end of the binding margin 5b as well. Moreover, the upper film 2b in the sheet 1b is removed in the form of a slit along the binding margin 5b (removed part 8b).

Accordingly, in the sheet 1b of laminating films, pictures and drawings or the like may be easily sandwiched while the upper film 2b is turned up when the pictures and drawings or the like are sandwiched between the upper film 2b and lower film 3b. When the sheet 1b is pressed while heating, it is stiffened and becomes one sheet. However, compared to other parts in the obtained sheet, the removed part 8b has low stiffness and is capable of easily bending the removed part 8b as a folding line because only the lower film 3b is left.

That is, in the sheet of laminating films according to the present invention, regardless of the size and the shape, one sheet having a binding margin which is capable of easily bending the removed part as a folding line by pressing the sheet of laminating films sandwiching pictures and drawings while it is heated may be obtained.

This invention solves the problems of the conventional laminating films described above by providing a sheet of laminating films that allow a binding margin to be made so that it may be bound as a book or a file.

### INDUSTRIAL APPLICABILITY

As mentioned above, the present invention allows the plurality of laminated sheets in which pictures and drawings or the like are sandwiched by the laminating films to be bound as a file. Then, by binding laminated drawings as a file, operators of river and harbor conservation works can use such clear drawings to the end without wetting by water or getting dirt.

In addition, menus of a restaurant or the like may be bound as a file that is easily used and that is not damaged even if it is used many times or that does not become old for good. While pictures are often taken by a digital camera and are printed by a printer in general homes lately, those pictures may be preserved by laminating and binding as a file. The colors of the laminated print pictures, including white parts, will not change.

While the embodiments of the present invention have thus been described with reference to the drawings, it should be understood that the present invention be not limited to the embodiments shown in the drawings. Various changes, modifications, and improvements can be made to the embodiments on the basis of knowledge of those skilled in the art without departing from the scope of the present invention.

This application is based on Japanese Patent Application No. 2004-62192, which is incorporated herein by reference into the United States application.

What is claimed is:

1. A sheet of laminating films comprising an upper film and a lower film overlapping each other for laminating pictures and drawings or the like by sandwiching them between the upper and lower films, wherein the upper and lower films are welded to provide a binding margin at a side edge of the sheet of laminating films, wherein the upper film and the lower film are welded to provide a welding part at an end part extending from one end of the binding margin, and wherein the upper film is removed in the form of a slit along the binding margin.

2. A sheet of laminating films comprising an upper film and a lower film overlapping each other for laminating pictures and drawings or the like by sandwiching them between the upper and lower films, wherein the upper and lower films are welded to provide a welding part at a side edge of the sheet of laminating films and wherein the upper film is removed in the form of a slit along an end part extending from one end of the welding part.
